(19) United States
(12) Patent Application Publication
(10) Pub. No.: US 2016/0014168 A1
(43) Pub. Date: Jan. 14, 2016

(54) METHODS FOR SHARING APPLICATIONS BETWEEN APPARATUSES AND SYSTEMS USING THE SAME

(71) Applicant: Wistron Corp., New Taipei City (TW)

(72) Inventors: Fang-Wen LIAO, New Taipei City (TW); Pen-Tai MIAO, New Taipei City (TW); Ping-Hung CHEN, New Taipei City (TW)

(21) Appl. No.: 14/568,430

(22) Filed: Dec. 12, 2014

(30) Foreign Application Priority Data
Jul. 8, 2014 (TW) 103123422

(51) Int. Cl. H04L 29/06; H04L 29/08

(52) U.S. Cl. CPC H04L 65/403; H04L 67/10

(57) ABSTRACT

The invention introduces a method for sharing applications between apparatuses, which contains at least the following steps. A processing unit of a first electronic apparatus discovers local applications to generate an application list, and sends the application list to a second electronic apparatus in a formatted message, wherein the application list contains at least paths storing the applications. After receiving an application path from the second electronic apparatus, the processing unit launches one corresponding application, generates an application window, and sends screen data containing at least the application window to the second electronic apparatus.

### CROSS REFERENCE TO RELATED APPLICATIONS

This Application claims priority of Taiwan Patent Application No. 103123422, filed on Jul. 8, 2014, the entirety of which is incorporated by reference herein.

### BACKGROUND

1. Technical Field

The present invention relates to a remote application control, and in particular to methods for sharing applications between apparatuses and systems using the same.

2. Description of the Related Art

Screen-sharing enables wired or wireless delivery of screen images to or from desktop computers, tablet computers, mobile phones, or other devices. It allows users to, for example, duplicate a display from a desktop computer onto a mobile phone. Typically, the mobile phone displays the whole screen image. When a user wants to execute one application running on the desktop computer by mobile phone, the mobile phone keep receiving a series of screen images from the desktop computer. The mobile phone further feeds back manipulation information to the desktop computer in response to the user's actions on the received screen images. Although the screen-sharing can achieve the object of remote application control, the transmission of screen images consumes excessive bandwidth. Thus, it is desirable to have methods for sharing applications between apparatuses and systems using the same to address the aforementioned drawbacks.

### BRIEF SUMMARY

An embodiment of the invention introduces a method for sharing applications between apparatuses, which contains at least the following steps. A processing unit of a first electronic apparatus discovers local applications to generate an application list, and sends the application list to a second electronic apparatus in a formatted message, wherein the application list comprises paths storing the applications. After receiving an application path from the second electronic apparatus, the processing unit launches one corresponding application, generates an application window, and sends screen data comprising the application window to the second electronic apparatus.

An embodiment of the invention introduces a system for sharing applications between apparatuses, which contains at least a first electronic apparatus. The first electronic apparatus contains at least a storage device, a communications interface and a processing unit. The processing unit, coupled to the storage device and the communications interface, discovers local applications stored in the storage device to generate an application list, wherein the application list comprises paths storing the applications, and sends the application list to a second electronic apparatus in a formatted message via the first communications interface. After receiving an application path from the second electronic apparatus via the first communications interface, the processing unit launches one corresponding application, generates an application window, and sends screen data comprising the application window to the second electronic apparatus via the first communications interface.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the system architecture of the application-sharing environment according to an embodiment of the invention;

FIG. 2 is the system architecture of an electronic device according to an embodiment of the invention;

FIG. 3 is a schematic diagram of two-phase sharing according to an embodiment of the invention;

FIG. 4 is a flowchart illustrating a method for generating an MMI, performed by a processing unit of a mobile phone, according to an embodiment of the invention;

FIG. 5 is a schematic diagram of a screen for selecting an application according to an embodiment of the invention;

FIG. 6 is a flowchart illustrating a method for manipulating applications remotely, performed by a processing unit of a mobile phone, according to an embodiment of the invention;

FIG. 7A is a flowchart illustrating a method for receiving screen data, performed by a processing unit of a mobile phone, according to an embodiment of the invention;

FIG. 7B is a flowchart illustrating a method for sending an input signal, performed by a processing unit of a mobile phone, according to an embodiment of the invention;

FIG. 8 is a flowchart illustrating a method for providing an application list, performed by a processing unit of a desktop computer, according to an embodiment of the invention;

FIG. 9 is a flowchart illustrating a method for providing application services, performed by a processing unit of a desktop computer, according to an embodiment of the invention; and

FIG. 10 is a flowchart illustrating a method for sharing screens, performed by a processing unit of a desktop computer, according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

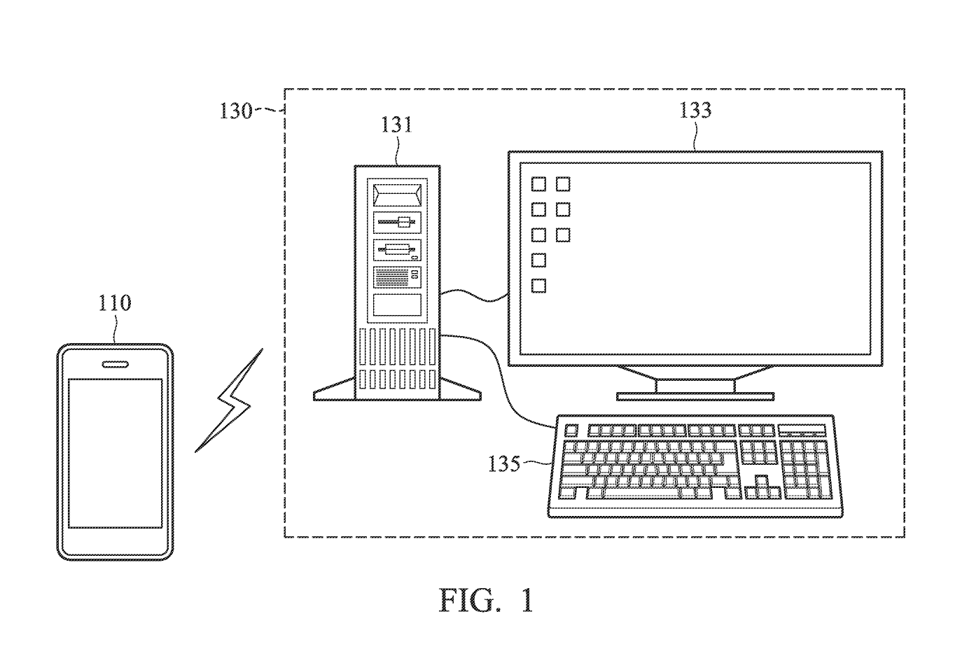

Embodiments of the invention are operated in the screen-sharing system. FIG. 1 illustrates the system architecture of the application-sharing environment according to an embodiment of the invention, containing a mobile phone 110 and a desktop computer 130. The desktop computer 130 may contain a main unit 131, a display device 133 and a keyboard 135. Either the mobile phone 110 or the display device 133 includes a display panel, such as a TFT-LCD (Thin-film transistor liquid-crystal display) panel, or an OLED (Organic Light-Emitting Diode) panel, to display input letters, alphanumeric characters and symbols, dragged paths, drawings, or screens provided by an application for the user to view. The mobile phone 110 may employ a wireless communications technology, such as the Wi-Fi Connect®, Bluetooth®, etc., to connect to the desktop computer 130. The desktop computer 130 running on a multi-tasking OS (Operating System) may execute several applications at the same time, such as a browser, a mail management client, a multimedia player, a word processing program, etc. The desktop computer 130 may use a screencasting technology, such as the Miracast®, etc., to duplicate a screen image onto a display unit of the mobile phone 110. The mobile phone 110 may be referred to as a screen-sharing receiver while the desktop computer 130 may be referred to as a screen-sharing source. Although the screen-sharing receiver shown in the embodiments is a mobile phone 110, it should be understood that alternative embodiments are contemplated, such as providing a portable device like a tablet computer, a notebook computer, etc., as a screen-sharing receiver. Although the screen-sharing source shown in the embodiments is a desktop computer 130, it should be understood that alternative embodiments are contemplated, such as providing a computer apparatus with a larger display, like a tablet computer, a notebook computer, etc., as a screen-sharing source. The connection between the screen-sharing source and receiver is not limited to wireless communications, it is also feasible to connect therebetween with wired cables, and the invention should not be limited thereto.

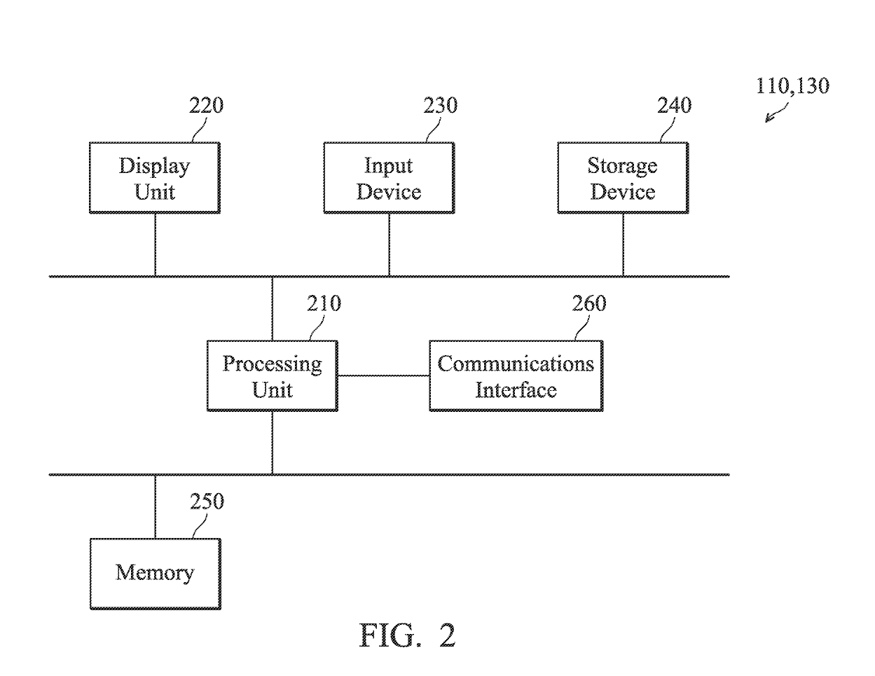

FIG. 2 is the system architecture of an electronic device according to an embodiment of the invention. The system architecture may be practiced in a mobile phone 110, a desktop computer 130 or another electronic device with computation capability. A processing unit 210 can be implemented in numerous ways, such as with dedicated hardware, or with general-purpose hardware (e.g., a single processor, multiple processors or graphics processing units capable of parallel computations, etc.) that is programmed using microcode or software instructions to perform the functions recited herein. The system architecture further includes a memory 250 for storing necessary data in execution, such as variables, data tables, etc., and a storage unit 240 for storing a wide range of electronic files, such as Web pages, documents, video files, audio files, etc. A communications interface 260 is included in the system architecture and the processing unit 210 can thereby communicate with another electronic device. An input device 230 may include a touch panel to help a user to make a gesture to control a running application. The gestures include, but are not limited to, a single-click, a double-click, a single-finger dragging, and a multiple finger dragging. The input device 230 may further include a keyboard, a keypad, a mouse, etc. A display unit 220 may include a display panel, such as a TFT-LCD (Thin film transistor liquid-crystal display) panel or an OLED (Organic Light-Emitting Diode) panel, to display input letters, alphanumeric characters, symbols, dragged paths, drawings, or screens provided by an application for the user to view.

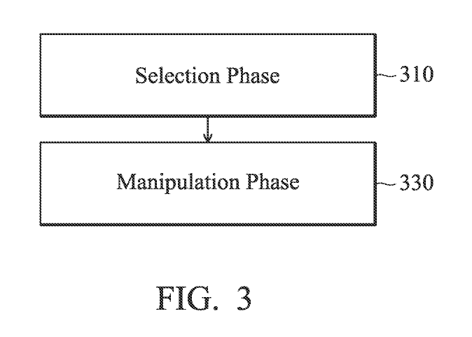

In order to improve the efficiency of application sharing, an embodiment of the invention introduces two-phase sharing to reduce the transmission of screen images. FIG. 3 is a schematic diagram of two-phase sharing according to an embodiment of the invention. The desktop computer 130 includes an application server employed to provide many applications to be remotely executed by the mobile phone 110. During the selection phase 310, the desktop computer 1130 sends an application list to the mobile phone 110, which has connected thereto, in a formatted message. The formatted message contains metadata of the applications and the mobile phone 110 can accordingly generate an MMI (Man-Machine Interface), which helps the user to select one of the applications. The metadata of each application includes a path, a name and a description. When the user selects one application via the MMI, the mobile phone 110 sends a message to the desktop computer 130 to start the selected application, resulting in the mobile phone 110 and the desktop computer 130 entering the manipulation phase 330. At the beginning of the manipulation phase 330, the desktop computer 130 launches the application selected by the mobile phone 110. Those skilled in the art will realize that, once the application is launched, the display device 133 of the desktop computer 130 displays an application window as part of the MMI to facilitate interaction with the user. Subsequently, the desktop computer 130 sends screen data to the mobile phone 110 at, for example, 40 frames per second, thereby enabling the mobile phone 110 to duplicate the same screen data on its display unit 220. The screen data may contain a compressed image, such as a JPEG (Joint Photographic Experts Group) image, etc., or an uncompressed image. Furthermore, when receiving information in an input signal from the user via the input device 230, such as a gesture, a set of coordinates, etc., the mobile phone 110 sends the information to the desktop computer 130 to help the desktop computer 130 to operate the corresponding application and accordingly to refresh screen data on the display device 133. It should be noted by those skilled in the art that the required bandwidth in the transmission of screen data is much higher than that in the transmission of the formatted message. The formatted message is used in the selection phase 310 to carry the application list (instead of periodically refreshing screen data by using the screen-sharing technology), yielding a reduction of bandwidth consumption between the desktop computer 130 and the mobile phone 110. It should also be noted by those skilled in the art that each application has an identical window interface and logics for operating the window interface. A common screen-sharing mechanism is provided in the manipulation phase 330 to assist the user with operating all different applications running on the desktop computer 130 via the mobile phone 110, resulting in the mobile phone 110 having no need to provide different remote operating logics for different applications.

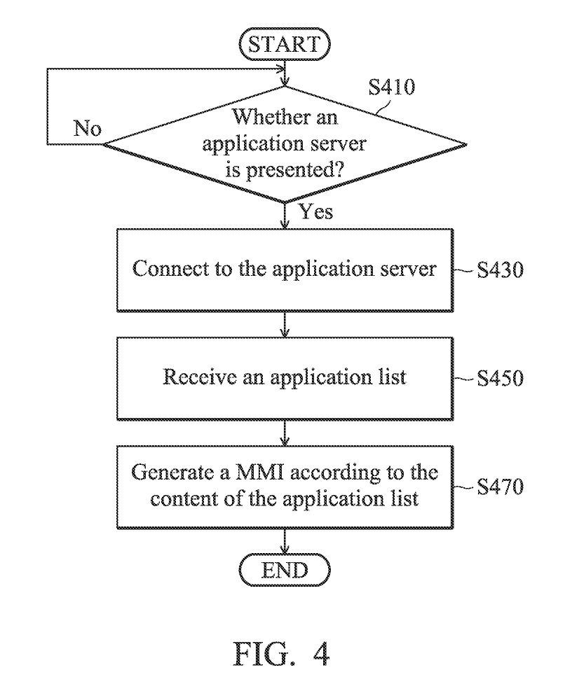

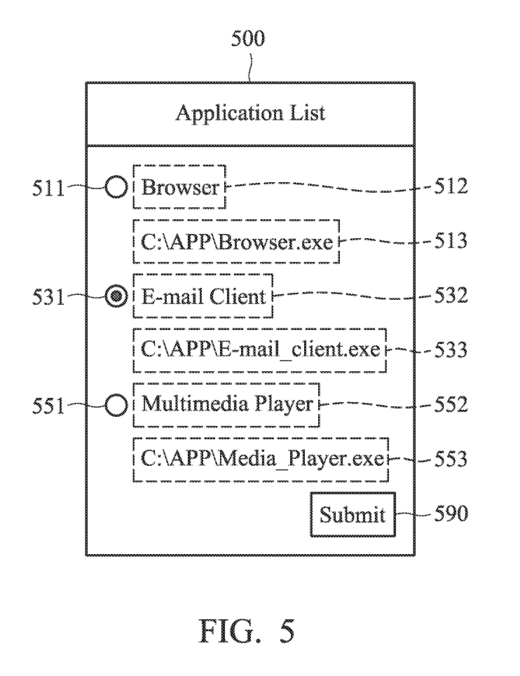

FIG. 4 is a flowchart illustrating a method for generating an MMI, performed by the processing unit 210 of the mobile phone 110, according to an embodiment of the invention. The method is practiced in an application-client main thread of the mobile phone 110, which is created and executed when an application client is launched. First, it is periodically determined whether an application server is presented (step S410). The processing unit 210 may broadcast a discovery message for exploring an application server in a subnet every five seconds via the communications interface 260, for example, the devices having an IP (Internet Protocol) address ranging from 192.168.0.1 to 192.168.0.255. After receiving the discovery message, the application server replies with an acknowledgement message to the mobile phone 110. When an application server is present (the “yes” path of step S410), the processing unit 210 connects via the communications interface 260 to the application server, for example, the application server executed by the processing unit 210 of the desktop computer 130 (step S430). When detecting that the mobile phone 110 has connected, the application server sends an application list to the mobile phone 110 in a formatted message. After receiving the application list (step S450), the processing unit 210 of the mobile phone 110 generates an MMI capable of interacting with a user according to the content of the application list (step S470). FIG. 5 is a schematic diagram of a screen for selecting an application according to an embodiment of the invention. Assume that the application list includes information about three applications, for example the browser, the e-mail client and the multimedia player: The application list describes that the executable program of the browser is stored in the path “C:\APP\Browser.exe” of the storage device 240 of the desktop computer 130; the executable program of the e-mail client is stored in the path “C:\APP\E-mail_client.exe” of the storage device 240 of the desktop computer 130; and the executable program of the multimedia player is stored in the path “C:\APP\Media_player.exe” of the storage device 240 of the desktop computer 130. The MMI generated by the processing unit 210 of the mobile phone 110 contains an operation screen 500, and the operation screen 500 displays application names 512, 532 and 552, and application paths 513, 533 and 553. It should be noted that the application paths are not necessary information to be displayed, and those skilled in the may not display the application paths on the operation screen 500. Moreover, those skilled in the art may devise an operation screen 500 to display auxiliary information to help the user to select one application, such as an application description. The operation screen 500 contains three radio buttons 511, 531 and 551 to assist the user to select the browser, the e-mail client or the multimedia player to be launched remotely. The operation screen 500 further contains a submit button 590. When the user presses the submit button 590, the processing unit 210 of the mobile phone 110 stores a selection result in the memory 250 according to the final settings of the radio buttons 511, 531 and 551. When the MMI is generated, the processing unit 210 also creates and executes an MMI main thread.

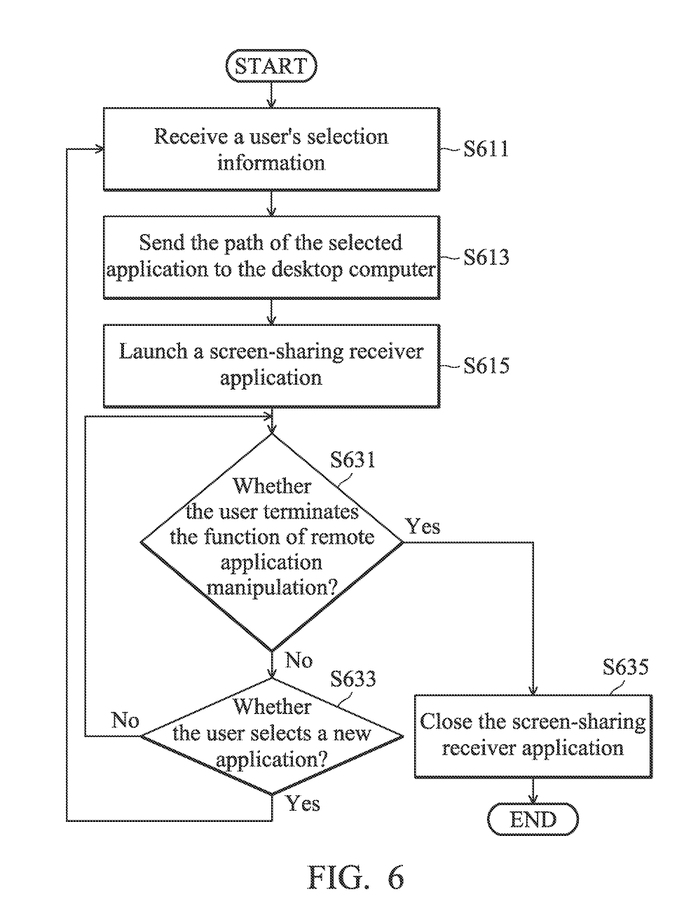

FIG. 6 is a flowchart illustrating a method for manipulating applications remotely, performed by the processing unit 210 of the mobile phone 110, according to an embodiment of the invention. The method is practiced in an MMI main thread of the mobile phone 110, which is created and executed when the MMI is generated. After receiving the user's selection information, (for example, information regarding which application on the application list shown in FIG. 5 is selected) (step S611), the path of the selected application is sent to the desktop computer 130, thereby enabling the desktop computer 130 to launch the application selected by the user (step S613), and a screen-sharing receiver application is launched (step S615). Specifically, in step S615, the processing unit 210 of the mobile phone 110 creates and executes a main thread and an input detection thread of the screen-sharing receiver application. It should be noted that, regardless of which application is selected, the user manipulates the application services provided by the application server of the desktop computer 130 through the common screen-sharing receiver application. Subsequently, it is determined whether the user terminates the function of remote application manipulation (step S631). If so, the screen-sharing receiver application is closed (step S635), and the whole process ends; otherwise, it is further determined whether the user selects a new application (step S633). In step S633, the user may manipulate the application list as shown in FIG. 5 to do the selection. Specifically, in step S635, the processing unit 210 of the mobile phone 110 terminates the main thread and the input detection thread of the screen-sharing receiver application. When the user selects a new application (the “yes” path of step S633), the process proceeds to step S611; alternatively, when the user does not select a new application (the “no” path of step S633), the process proceeds to step S631.

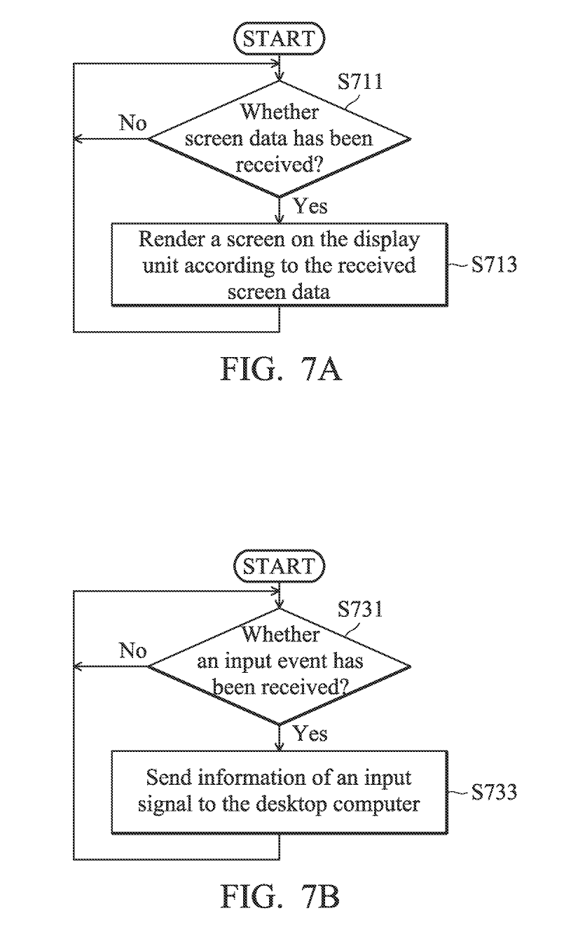

FIG. 7A is a flowchart illustrating a method for receiving screen data, performed by the processing unit 210 of the mobile phone 110, according to an embodiment of the invention. The method is practiced in a main thread of the screen-sharing receiver application of the mobile phone 110, which is created and executed when the processing unit 210 launches the screen-sharing receiver application. The process repeatedly detects whether screen data has been received from the desktop computer 130 via the communications interface 260 (step S711). If so, a screen is rendered on the display unit 220 according to the received screen data (step S713). FIG. 7B is a flowchart illustrating a method for sending input signals, performed by the processing unit 210 of the mobile phone 110, according to an embodiment of the invention. The method is practiced in an input detection thread of the screen-sharing receiver application of the mobile phone 110, which is created and executed when the processing unit 210 launches the screen-sharing receiver application. The process repeatedly detects whether an input event has been received from the input device 230 (step S731). If so, information of an input signal, such as a mouse action, a gesture, a set of coordinates, a moving distance, etc., is sent to the desktop computer 130 (step S733). In step S733, the mobile phone may employ the UIBC (User Input Back Channel) to send the information of the input signal to the desktop computer 130.

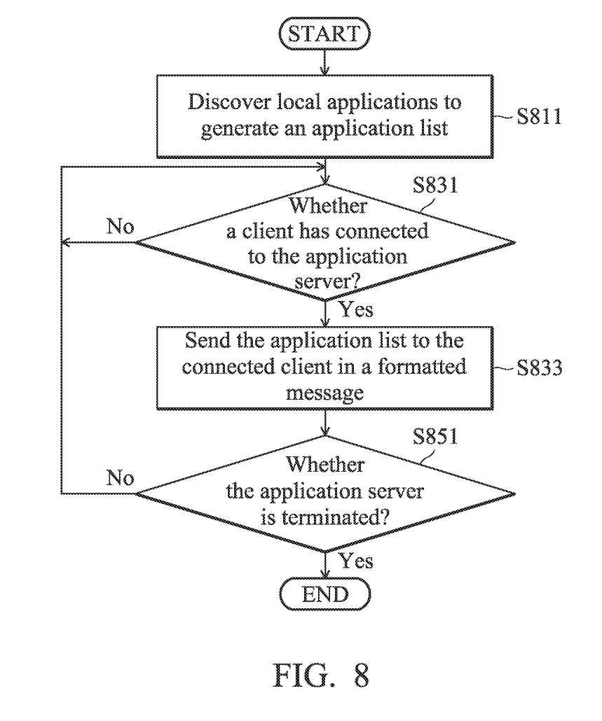

When the application server starts to provide services, the processing unit 210 of the desktop computer 130 creates and executes an application-list-providing thread, a server main thread and a screen-sharing source main thread. The server main thread is used to deliver a message for launching a specified application and a client address, which are sent by a client, to the screen-sharing source main thread. The screen-sharing source main thread delivers information of an input signal, which is sent by a client, to the specified application to refresh the screen and sends the refreshed screen to the client. FIG. 8 is a flowchart illustrating a method for providing an application list, performed by the processing unit 210 of the desktop computer 130, according to an embodiment of the invention. The method is practiced in an application-list-providing thread of the desktop computer 130, which is created and executed when the processing unit 210 starts an application server. First, local applications are discovered to generate the application list (step S811). In step S811, the processing unit 210 may scan a specified directory of the storage device 240 to find out all executable application programs, or read relevant records from a database or a file to obtain necessary information for the application list. Next, it is periodically detected whether a client has connected to the application server (step S831). Once a connected client has been found (the “yes” path of step S831), the application list is sent to the connected client in a formatted message, such as the mobile phone 110 (step S833). Moreover, the processing unit 210 of the desktop computer 130 further determines whether the application server is terminated (step S851). If so, the whole process ends; otherwise, the process continues to detect whether another client has connected to the application server (step S831).

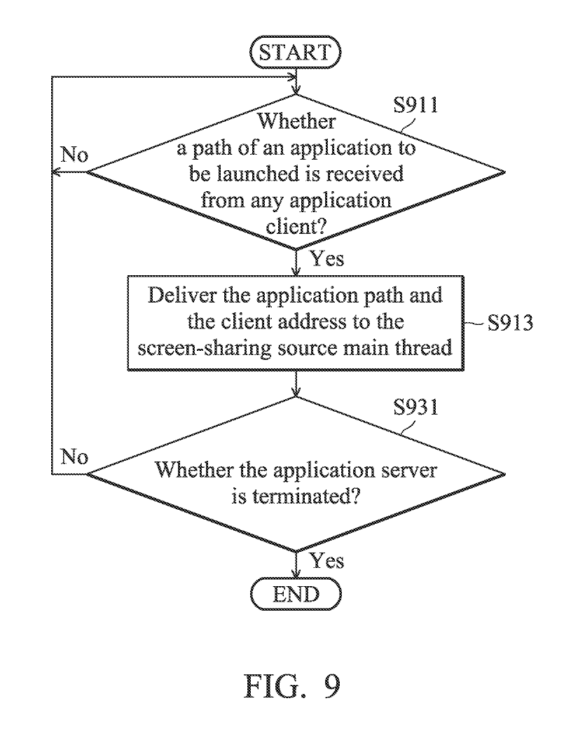

FIG. 9 is a flowchart illustrating a method for providing application services, performed by the processing unit 210 of the desktop computer 130, according to an embodiment of the invention. The method is practiced in a server main thread of the desktop computer 130, which is created and executed when the processing unit 210 starts an application server. The process periodically inspects whether the path of an application to be launched is received from any application client (step S911). After receiving a path of an application to be launched from an application client (the “yes” path of step S911), the application path and the client address are delivered to the screen-sharing source main thread (step S913). The message delivery illustrated in step S913 may be referred to as a named pipe. Furthermore, the processing unit 210 of the desktop computer 130 further determines whether the application server is terminated (step S931). If so, the whole process ends; otherwise, the processing unit 210 of the desktop computer 130 further inspects whether a path of an application to be launched is received from any application client (step S911).

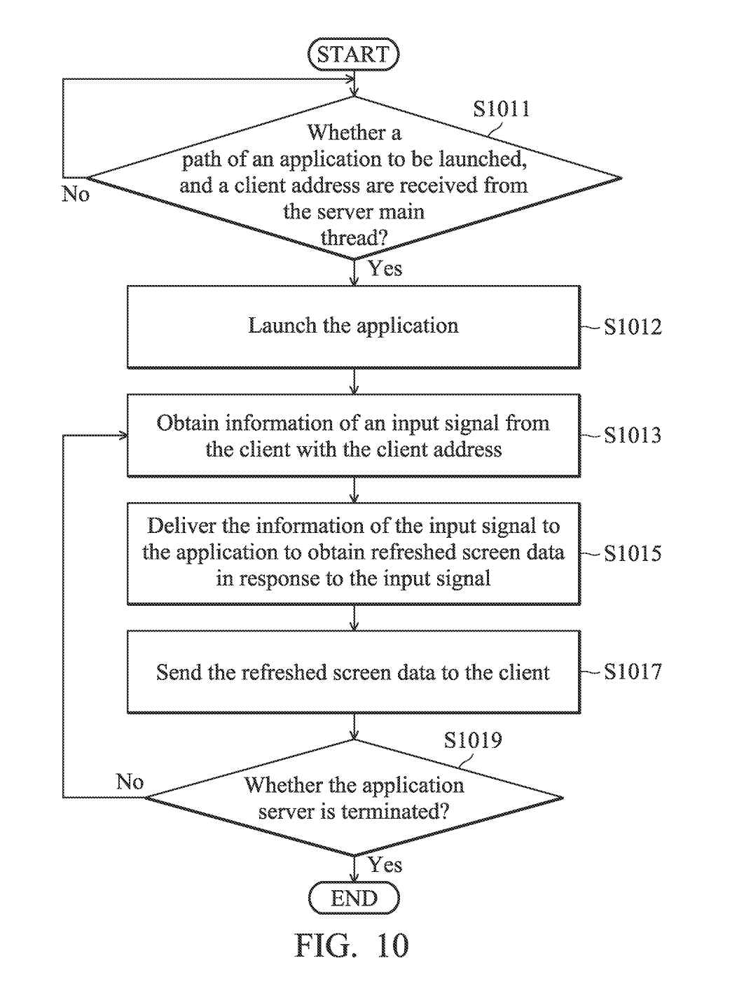

FIG. 10 is a flowchart illustrating a method for sharing screens, performed by the processing unit 210 of the desktop computer 130, according to an embodiment of the invention. The method is practiced in a screen-sharing source main thread of the desktop computer 130, which is created and executed when the processing unit 210 starts an application server. The process periodically inspects whether a path of an application to be launched and a client address are received from the server main thread (step S1011). After receiving the path of an application to be launched and the client address are received from the server main stream (the “yes” path of step S1011), the processing unit 210 of the desktop computer 130 launches the designated application according to the received path (step S1012), obtains information of an input signal from the client with the client address (step S1013), delivers the information of the input signal to the designated application to obtain refreshed screen data in response to the input signal (step S1015), and sends the refreshed screen data to the client (step S1017). In step S1013, the desktop computer 130 may employ the UIBC to receive the information of the input signal from the client. In step S1015, after interpreting the information of the input signal and performing a corresponding operation, the application refreshes its application window responding to the input signal and transmits the screen data comprising the refreshed application window to the screen-sharing source main thread. Moreover, the processing unit 210 of the desktop computer 130 further determines whether the application server is terminated (step S1019). If so, the whole process ends; otherwise, the processing unit 210 of the desktop computer 130 further obtains refreshed screen data responding to a further input signal sent from the client via the application and sends the refreshed screen data to the client (steps S1013 to S1017).

Although the embodiment has been described as having specific elements in FIG. 2, it should be noted that additional elements may be included to achieve better performance without departing from the spirit of the invention. While the process flows described in FIGS. 4, 6 to 10 each include a number of operations that appear to occur in a specific order, it should be apparent that these processes can include more or fewer operations, which can be executed in series or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for sharing applications between apparatuses, comprising:
discovering, by a first processing unit of a first electronic apparatus, a plurality of applications to generate an application list;
sending, by the first electronic apparatus, the application list to a second electronic apparatus in a formatted message, wherein the application list comprises a plurality of paths storing the applications;
after the first electronic apparatus receives an application path from the second electronic apparatus, launching, by the first processing unit, a corresponding application and generating an application window; and
sending, by the first electronic apparatus, screen data comprising the application window to the second electronic apparatus.

2. The method of claim 1, wherein the first electronic apparatus comprises an application server and the second electronic apparatus is a client.

3. The method of claim 1, further comprising:
after the first electronic apparatus receives information of an input signal from the second electronic apparatus, delivering, by the first processing unit, the information of the input signal to the launched application to refresh the application window; and
sending, by the first electronic apparatus, screen data comprising the refreshed application window to the second electronic apparatus.

4. The method of claim 3, wherein the first electronic apparatus comprises a screen-sharing source, and the screen-sharing source sends the screen data comprising the application window and the screen data comprising the refreshed application window to the second electronic apparatus.

5. The method of claim 4, wherein the screen-sharing source receives the information of the input signal from the second electronic apparatus by employing a UIBC (User Input Back Channel).

6. The method of claim 3, further comprising:
receiving, by a second processing unit of the second electronic apparatus, the application list from the first electronic apparatus;
generating, by the second electronic apparatus, an MMI (Man Machine Interface) according to content of the application list;
obtaining, by the second electronic apparatus, a selection signal for indicating which application to be launched via the MMI;
obtaining, by the second electronic apparatus, the application path of the application to be launched; and
sending, by the second electronic apparatus, the application path to the first electronic apparatus.

7. The method of claim 6, further comprising:
receiving, by the second electronic apparatus, the screen data comprising the application window or the refreshed application window from the first electronic apparatus; and
rendering, by the second electronic apparatus, the application window or the refreshed application according to the received screen data.

8. The method of claim 7, wherein the second electronic apparatus comprises a screen-sharing receiver and the screen-sharing receiver receives the screen data comprising the application window or the refreshed application window from the first electronic apparatus.

9. The method of claim 7, further comprising:
determining, by the second electronic apparatus, whether an input event is received periodically; and
when receiving the input event, sending, by the second electronic apparatus, the information of the input signal to the first electronic apparatus.

10. The method of claim 9, wherein the second electronic apparatus comprises a screen-sharing receiver and the screen-sharing receiver sends the information of the input signal to the first electronic apparatus by a UIBC (User Input Back Channel).

11. A system for sharing applications between apparatuses, comprising:
a first electronic apparatus, comprising:
a storage device;
a first communications interface; and
a first processing unit, coupled to the storage device and the first communications interface, discovering a plurality of applications stored in the storage device to generate an application list, wherein the application list comprises a plurality of paths storing the applications; sending the application list to a second electronic apparatus in a formatted message via the first communications interface; after receiving an application path from the second electronic apparatus via the first communications interface, launching a corresponding application and generating an application window; and sending screen data comprising the application window to the second electronic apparatus via the first communications interface.

12. The system of claim 11, wherein the first electronic apparatus comprises an application server and the second electronic apparatus is a client.

13. The system of claim 11, wherein the first processing unit, after receiving information of an input signal from the second electronic apparatus via the first communications interface, delivers the information of the input signal to the launched application to refresh the application window; and sends screen data comprising the refreshed application window to the second electronic apparatus via the first communications interface.

14. The system of claim 13, wherein the first processing unit, when executing a thread of a screen-sharing source, sends the screen data comprising the application window and the screen data comprising the refreshed application window to the second electronic apparatus via the first communications interface.

15. The system of claim 14, wherein the first processing unit, when executing the thread of the screen-sharing source, receives the information of the input signal from the second electronic apparatus by employing a UIBC (User Input Back Channel).

16. The system of claim 13, further comprising:
a second electronic apparatus, comprising:
a display unit;
a second communications interface; and
a second processing unit, coupled to the display unit and the second communications interface, receiving the application list from the first electronic apparatus via the second communications interface;
generating an MMI (Man Machine Interface) according to content of the application list; obtaining a selection signal to indicate which application to be launched via the MMI; obtaining the application path of the application to be launched; and sending the application path to the first electronic apparatus via the second communications interface.

17. The system of claim 16, wherein the second processing unit receives the screen data comprising the application window or the refreshed application window from the first electronic apparatus via the second communications interface; and renders the application window or the refreshed application on the display unit according to the received screen data.

18. The system of claim 17, wherein the second processing unit, when executing a thread of a screen-sharing receiver, receives the screen data comprising the application window or the refreshed application window from the first electronic apparatus via the second communications interface.

19. The system of claim 18, wherein the second processing unit determines whether an input event is received periodically; and when receiving the input event, sends the information of the input signal to the first electronic apparatus via the second communications interface.

20. The system of claim 19, wherein the second processing unit, when executing a thread of a screen-sharing receiver, sends the information of the input signal to the first electronic apparatus by a UIBC (User Input Back Channel).
